(19) United States
(12) Patent Application Publication
(10) Pub. No.: US 2026/0135320 A1
(43) Pub. Date: May 14, 2026

(54) HIGH SPEED, RUGGEDIZED CONNECTOR

(71) Applicant: Amphenol East Asia Electronic Technology (Shenzhen) Co., Ltd., Shenzhen (CN)

(72) Inventors: Koen Maddens, Hofstade (BE); Danren He, Shenzhen (CN); JianQiang Shen, Shenzhen (CN)

(73) Assignee: Amphenol East Asia Electronic Technology (Shenzhen) Co., Ltd., Shenzhen (CN)

(21) Appl. No.: 19/119,392

(22) PCT Filed: Oct. 10, 2022
(86) PCT No.: PCT/CN2022/124355

§ 371 Date: Apr. 8, 2025

(51) Int. Cl. H01R 13/436; H01R 13/506; H01R 13/641; H01R 43/20

(52) U.S. Cl. CPC H01R 13/4362; H01R 13/506; H01R 13/641; H01R 43/20

(57) ABSTRACT

A modular connector that economically provides high signal integrity in a harsh environment, such as an automobile. The connector may include structures that provide precise and stable positioning of conductors, such as contacts. Those structures may include a contact carrier position assurance component (CCPA) that ensures that a contact carrier is and remains latched in a designed position. The contact carrier position assurance component may slide into a closed position, locking a plurality of contact carriers into the designed position simultaneously. For an unsealed connector, the CCPA may slide into a connector housing in a direction transverse to the direction in which the contact carriers are inserted into the housing. For a sealed connector, the CCPA may slide into the closed position in the same direction in which the contact carriers are inserted, facilitating sealing the connector.

### BACKGROUND

This patent application relates generally to interconnection systems, such as those including electrical connectors, used to interconnect electronic assemblies, and more specifically to interconnection systems for harsh environments, such as in a vehicle.

Electrical connectors are used in many electronic systems. It is generally easier and more cost effective to manufacture a system as separate electronic assemblies, which may be joined together with electrical connectors. Connectors may be used for interconnecting assemblies so that the assemblies may operate together as part of a system. Connectors, for example, may be mounted on printed circuit boards within two assemblies that are connected by mating the connectors. In other systems, it may be impractical to join two printed circuit boards by directly mating connectors on those printed circuit boards. For example, when the system is assembled, those printed circuit boards may be separated by too great a distance for a direct connection between connectors mounted in the printed circuit boards.

In some systems, connections between assemblies may be made through cables. The cables may be terminated with connectors that mate with connectors mounted on a printed circuit board. In this way, connections between assemblies may be made by plugging a connector that is part of cable assembly into a connector that is mounted to printed circuit board. In other system architectures, a connector terminating a cable may be mated with another connector terminating another cable.

An example of a system in which assemblies are connected through cables is a modern automobile. For example, automotive vehicles include electronic control units (ECUs) for controlling various vehicle systems, such as the engine, transmission (TCUs), security system, emissions control, lighting, advanced driver assistance system (ADAS), entertainment system, navigation system, and cameras. The ECUs may be manufactured as separate assemblies and connected over one or more vehicle networks formed with cables routed between these assemblies. To simplify manufacture of an automobile, the assemblies may be formed separately and then connected via cables that are terminated with connectors that enable connections to mating connectors terminating other cables or attached to printed circuit boards within the assemblies.

An automobile presents a harsh environment for an electrical connector. The automobile may vibrate, which can cause a connector to unmate and cease working entirely. Even if the vibration does not completely prevent operation of the connector, it can cause electrical noise, which can interfere with operation of electronics joined through interconnects including connectors. Noise, for example, may result from relative movement of components within connectors, which can change the electrical properties of the connector. Variations in the electrical properties, in turn, cause variation in the signals passing through the interconnect, which is a form of noise that interferes with processing the underlying signal.

In an automotive environment, electrical noise might also arise from automotive components that generate electromagnetic radiation. That radiation can couple to the conductive structures of a connector, creating noise on any signals passing over those conductive structures. In an automobile, any of a number of components might generate electromagnetic radiation, such as spark plugs, alternators or power switches. Noise can be particularly disruptive for high-speed signals such as those used to communicate data over an automobile network.

### SUMMARY OF THE INVENTION

Concepts as disclosed herein may be embodied as an electrical connector, comprising (i) an insulative housing comprising a chamber and a channel; (ii) a position assurance component comprising an opening having a channel and a surface adjacent the channel; and (iii) a contact carrier comprising a tab; wherein, the position assurance component is slidably mounted in the insulative housing and configured to slide between an open position in which the channel of the insulative housing, the channel of the position assurance component, and the tab on the contact carrier align and a closed position in which the surface of the position assurance component aligns with the channel of the insulative housing.

In another aspect, an electrical connector may comprise: (i) an insulative housing comprising a chamber; (ii) a position assurance component comprising an opening and a surface; and (iii) a contact carrier having a tab (1611) and being positioned within the chamber; wherein: the contact carrier extends through the opening of the position assurance component; and the position assurance component is positioned such that the surface interferes with the tab of the contact carrier so as to prevent the contact carrier from being withdrawn from the chamber of the insulative housing and the opening in the position assurance component.

In yet another aspect, an electrical connector subassembly may comprise (i) an insulative housing (1609) comprising a chamber (1622) having a channel (1628); (ii) a position assurance component (1630) comprising an opening (1631) having a channel (1626) and a surface adjacent the channel; and wherein, the position assurance component is slidably mounted in the insulative housing to slide between an open position in which the channel (1628) of the insulative housing (1609) and the channel (1626) of the position assurance component align and a closed position in which the surface of the position assurance component aligns with the channel (1628) on the insulative housing (1609); the position assurance component (1630) comprises a latch configured to engage a complementary structure in the insulative housing when the position assurance component is in the open position.

In yet another aspect, a method of operating an electrical connector comprising an insulative housing (1603) comprising a chamber (1612) and a latch (1654) projecting into the chamber and a position assurance component (1650) comprising a body with an opening (1652) therethrough and a projecting member, the method comprising: (i) sliding a contact carrier through the opening in the body of the position assurance component and into the chamber of the insulative housing until a tab of the contact carrier engages the latch of the housing; and (ii) sliding the position assurance component into the chamber until the projecting member is adjacent the latch such that disengagement of the latch and the tab are restrained by the projecting member.

In yet another aspect, an electrical connector may comprise: (i) an insulative housing (1603) comprising a chamber (1612) and a latch (1654) adjacent to the chamber; (ii) a position assurance component (1650) comprising a body with an opening (1652) therethrough, a projecting member, and a slot separating the projecting member from the body; and (iii) a contact carrier (1606) having a tab (1611) extending through the opening of the position assurance component and disposed within the chamber of the insulative housing; wherein the latch (1654) of the housing engages the tab (1611) of the contact carrier (1606) so as to retain the contact carrier (1606) in a position within the chamber and the position assurance component (1650) is positioned such that the latch is disposed within the slot such that motion of the latch is restrained.

In yet another aspect, a method of operating an electrical connector comprising an insulative housing (1603) comprising a chamber (1612) and a latch (1654) adjacent to the chamber, a position assurance component (1650) comprising a body with an opening (1652) therethrough, a projecting member, and a slot separating the projecting member from the body, comprises: (i) sliding the contact carrier into the chamber of the insulative housing until the tab of the contact carrier engages the latch of the housing; and (ii) sliding the position assurance component into the insulative housing until the latch of the insulative housing is disposed in the slot of the position assurance component.

### BRIEF DESCRIPTION OF DRAWINGS

The accompanying drawings are not limited to the dimensions shown. For purposes of clarity, not every component may be labeled in every drawing. In the drawings:

FIG. 1 is a perspective view of an illustrative interconnection system, in accordance with some embodiments.

FIG. 2 is an exploded perspective view of the illustrative board connector 100 of FIG. 1.

FIG. 3A is a sectional view of the illustrative board connector 100 of FIG. 1.

FIG. 3B is a rear view of the illustrative board connector of FIG. 3A.

FIG. 4A is a perspective view of an illustrative multiport board connector.

FIG. 4B is a sectional view of the illustrative multiport board connector of FIG. 4A.

FIG. 5 is a perspective view of cable connector 200 of FIG. 1.

FIG. 6 is an exploded perspective view of the illustrative cable connector of FIG. 5.

FIG. 7 is a sectional view of the illustrative cable connector of FIG. 5.

FIG. 8 is a perspective, exploded view of an illustrative unsealed multi-port cable connector terminating a cable assembly.

FIG. 9 is a perspective view of an illustrative contact carrier position assurance component 1630.

FIG. 10 is a perspective view of housing components of the illustrative unsealed multi-port cable connector of FIG. 8 assembled into a housing subassembly for an electrical connector, with the contact carrier position assurance component inserted and engaged at an open position, without contact carriers inserted in the subassembly.

FIG. 11 is a perspective view of the illustrative contact carrier position assurance component of FIG. 9 with an enlarged view of a latch shown in a callout.

FIG. 12 is a side view of the illustrative electrical connector subassembly of FIG. 10 with an enlarged view of the latch engaged to the housing to hold the contact carrier position assurance component within a housing in an open position.

FIG. 13 is a sectional view of the illustrative electrical connector subassembly with the contact carrier position assurance component latched in the open position.

FIG. 14 is a perspective view of the illustrative unsealed multi-port cable connector of FIG. 8, with the contact carriers inserted into the housing with the contact carrier position assurance component in the open position.

FIG. 15 is a sectional view of the illustrative unsealed multi-port cable connector in the state illustrated in FIG. 14.

FIG. 16 is a perspective view of the illustrative unsealed multi-port cable connector of FIG. 8, with the contact carrier position assurance component slid to a closed position.

FIG. 17A is a perspective view of the illustrative contact carrier position assurance component of FIG. 9 and the contact carriers, with the carrier position assurance component in the open position.

FIG. 17B is a perspective view of the illustrative contact carrier position assurance component of FIG. 9 and the contact carriers, with the contact carrier position assurance component in a closed position.

FIG. 17C is a top sectional view of the illustrative unsealed multi-port cable connector, with the contact carriers and contact carrier position assurance component inserted within the housing and in the closed position.

FIG. 18 is a sectional view of the illustrative multi-port cable connector of FIG. 8 with the contact carriers and contact carrier position assurance component inserted within the housing, with the contact carrier position assurance component in the closed position.

FIG. 19 is a side sectional view of the illustrative multi-port cable connector of FIG. 8 showing retention of the contact carriers within the housing by a wall of the contact carrier position assurance component in the closed position blocking a tab on the contact carrier, with an enlarged view of the tab shown in a callout.

FIG. 20 is a side view of the illustrative unsealed multi-port cable connector of FIG. 8 showing the contact carrier position assurance component latched in a closed position within the housing.

FIG. 21 is a perspective, exploded view of an illustrative sealed multi-port cable connector.

FIG. 22 is a sectional, perspective view of housing components of the illustrative sealed multi-port cable connector of FIG. 21 assembled into a connector subassembly.

FIG. 23 is a perspective view of two illustrative contact carrier position assurance components of the illustrative sealed multi-port cable connector of FIG. 21, with a contact carrier inserted into one of the contact carrier position assurance components.

FIG. 24A is a sectional view of the illustrative sealed multi-port cable connector of FIG. 21 with contact carriers retained within the housing by a primary latch, with an enlarged view of the latch shown in a callout.

FIG. 24B is a sectional view of the illustrative sealed multi-port cable connector of FIG. 21 showing the contact carrier position assurance component slid into a position blocking the primary latch.

FIG. 24C is a rear perspective view of the illustrative sealed multi-port cable connector of FIG. 21 with a cover retaining the contact carrier position assurance component in the position blocking the primary latch.

FIG. 25 is a sectional view of the illustrative sealed multi-port cable connector of FIG. 21 showing a seal and cover blocking the contact carrier position assurance component.

### DETAILED DESCRIPTION

The inventors have recognized and appreciated techniques for making a connector for providing high data rate transmission that may be economically manufactured yet operate reliably in the harsh environment presented by an automobile. Such a connector would be suitable for interconnecting assemblies in an automotive network, for example. These techniques may be applied in a modular connector system in which a set of components may be combined to form connectors in any of multiple configurations. The cost associated with manufacturing connectors of the types described herein may be reduced by designing the parts of the connectors to be modular.

The inventors have recognized and appreciated various techniques that may be applied to the components of the connector system to provide connections with high signal integrity (SI). The SI improvements may result from controlling the electrical properties of the signal paths through the connector and/or from configuring the connector to operate effectively, notwithstanding the rugged automotive environment in which the connector is used. Techniques disclosed herein may provide for mechanical and/or electrical stability of electrical conductors within a connector.

For example, one connector configuration may be formed from an insulative outer housing that establishes at least a mating interface of the connector. The insulative outer housing may provide latching features. The set of components may include insulative outer housings in complementary configurations, which may be used to form two connector configurations that will mate and latch to each other. The insulative housing may comprise a chamber and a channel.

A cable connector may be assembled by inserting one or more contact carriers, each terminating one or more cables into the chamber of the insulative housing. The contact carriers may have a tab that aligns with a channel in the connector housing. A contact carrier position assurance component may ensure that the contact carriers of the connector are properly positioned in the connector and remain properly positioned during use of the connector, despite shock and vibration that might otherwise tend to dislodge the contact carriers from their intended position. Ensuring the contact carriers are securely retained in their designed positions reduces impedance discontinuities in a mated pair of connectors and reduces vibration induced noise.

A contact carrier position assurance component may have a design that facilitates simple and reliable manufacture of a connector by engaging with multiple contact carriers while in an open position. Moving the position assurance component into a closed position may lock those multiple contact carriers in place.

A connector, for example, may comprise a position assurance component comprising an opening, a channel, and a surface adjected to the channel. Each connector may also comprise a contact carrier comprising a tab. The position assurance component may be slidably mounted in the insulative housing and configured to slide between (i) an open position in which the channel of the insulative housing, the channel of the position assurance component, and the tab on the contact carrier align, and (ii) a closed position in which the surface of the position assurance component aligns with the cannel of the insulative housing.

The position assurance component may also have a wall bounding its channel wherein the surface comprises one side of the wall so that when the position assurance component is in a closed position, the surface interferes with withdrawal of the tab of the contact carrier through the channel.

Alternatively or additionally, an electrical conductor may comprise an insulative housing comprising a chamber, a position assurance component comprising an opening and a surface, and a contact carrier having a tab and being positioned within the chamber. The contact carrier may extend through the opening of the position assurance component and the position assurance component may be positioned such that its surface interferes with the tab of the contact carrier to prevent the contact carrier from being withdrawn from the chamber of the insulative housing and the opening of the position assurance component.

The position assurance component may also comprise a protrusion and the insulative housing may also comprise a first rut such that the protrusion of the position assurance component rests within the first rut of the insulative housing to hold the position assurance component in a first position within the insulative housing. The insulative housing may also comprise a second rut wherein the protrusion of the position assurance component rests within the second rut of the insulative housing to hold the position assurance component in a second position within the insulative housing. The first position may correspond to an open position and the second position may correspond to a closed position, for example.

Use of techniques as described herein may be facilitated by providing a housing subassembly for an electrical connector. The subassembly, for example, may include an insulative housing with a contact carrier position assurance component retained in the housing. The contact carrier position assurance component, for example, may be latched in the open position. Such a subassembly may comprise an insulative housing comprising a chamber and a channel, a position assurance component comprising an opening, a channel, and a surface adjacent to the channel wherein the position assurance component is slidably mounted in the insulative housing to slide between (i) an open position in which the channel of the insulative housing and the channel of the position assurance component align and (ii) a closed position in which the surface of the position assurance component aligns with the channel of the insulative housing and wherein the position assurance component comprises a latch configured to engage a complementary structure in the insulative housing when the position assurance component is in the open position.

Alternatively or additionally, the contact carrier may latch the housing and position assurance component may slide over one or more contact carriers into a closed position in which the latch is restrained from unlatching. An electrical connector, for example, may comprise (i) an insulative housing comprising a chamber and a latch adjacent to the chamber, (ii) a position assurance component comprising a body with an opening therethrough, a projecting member, and a slot separating the projecting member from the body, and (iii) a contact carrier having a tab extending through the opening of the position assurance component and disposed within the chamber of the insulative housing, wherein the latch of the housing engages the tab of the contact carrier to retain the contact carrier in a position within the chamber, and the position assurance component is positioned such that the latch is disposed within the slot such that the motion of the latch is restrained. Alternatively or additionally, sliding the position assurance component into the insulative housing may position the projecting member of the position assurance component to block motion of the latch of the insulative housing to unlatch from the tab.

These techniques may be used singly or in combination. These techniques are illustrated below in connection with an interconnection system that may be used, for example, to make physical connections between assemblies in an automobile.

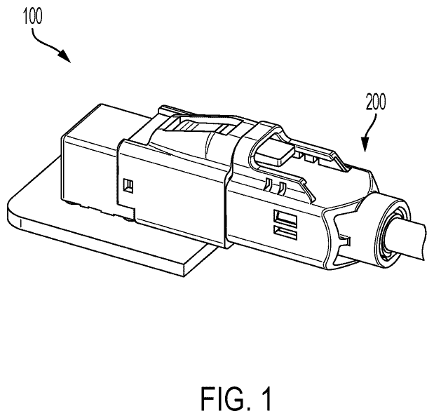

FIG. 1 is a perspective view of an illustrative interconnection system, in accordance with some embodiments. The interconnection system may be used to connect two electronic devices to one another. In some embodiments, interconnection system is used in high data rate transmission applications (e.g., in applications including ECUs of automotive vehicles). In this example, the interconnection system comprises a board connector 100 and a cable connector 200.

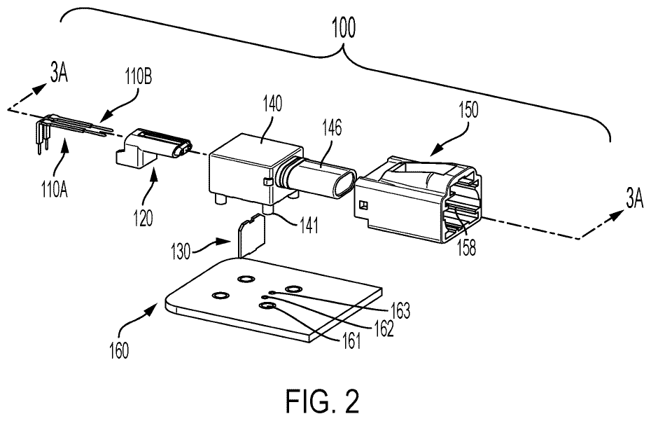

FIG. 2 is an exploded perspective view of the illustrative board connector 100 of FIG. 1 when not mated to cable connector 200, in accordance with some embodiments. Board connector 100 includes an opening 158 of the housing 150, which may be arranged to allow passage of mating contacts therethrough. The mating interface of board connector 100 may be disposed within opening 158.

Board connector 100 also includes a conductive housing 140. Conductive housing 140 may be a die cast component, for example. In this example, conductive housing has a mating portion 146 that extends into opening 158 when insulative housing 150 is attached to conductive housing 140.

Conductive housing 140 may include a chamber into which a terminal assembly is inserted. In this example, a terminal assembly may be formed by insulator 120 and one or more electrical conductors held by insulator 120. As shown, board connector 100 includes electrical conductors that may serve as signal conductors. In this example, a pair of electrical conductors is shown such that the illustrated terminal assembly is configured for passing a differential signal. In addition to transmitting one or more signals through the connector, the electrical conductors may have a mating contact portion at one end, a tail at the opposite end and an intermediate portion therebetween. Accordingly, the electrical conductors may serve as contacts for the connector.

In the example of FIG. 2, the mating contact portions of the electrical conductors are shaped as pins such that board connector 100 is configured as a header. In other embodiments, the mating contact portions of the electrical conductors in a header connector may be shaped as blades or have other shapes. Alternatively or additionally, in some embodiments, a board connector may have electrical conductors with mating contact portions shaped as receptacles. In the example of FIG. 2, the tails of the electrical conductors are shaped as posts. Posts, for example, may be mounted to a printed circuit board using plated through hole or pin in paste soldering techniques.

FIG. 2 illustrates a plurality of mating contacts, including contacts 110A and 110B (also referred to herein as “terminals”). The mating contact portions of the terminals extend into opening 158. Tails of contacts 110A and 110B extend from a mounting interface of board connector 100 for mounting to a printed circuit board 160. Contacts 110A and 110B may be electrically connected to holes 162 and 163 on a board 160. In some examples, the board 160 may be a printed circuit board (PCB).

Opening 158 may be shaped and sized to receive a mating connector therein. The mating connector may include mating contacts configured to electrically connect to contacts 110A and 110B when the interconnection system is in the mated configuration.

One or more mating contacts may be held within insulator 120 to form a terminal assembly. The insulator may be shaped and sized to receive the mating contacts. For example, the contacts 110A and 110B may pass through openings of insulator 120. The insulator 120 can be inserted into a cavity within conductive housing 140. In this way, conductive housing will partially encircle the terminal assembly, and the electrical conductors in the terminal assembly.

Conductive housing 140 may further include attachment posts, configured to electrically and mechanically connect conductive housing 140 to the board 160. For example, the attachment posts may extend into holes 161, which may be ground vias. By grounding conductive housing 140, it may serve as a shield for the terminal assembly, and the pair of conductors in the terminal assembly.

The board connector 100 may include one or more additional shield members, here illustrated as shield 130. Shield 130 is also inserted into the cavity of conductive housing 140, to further encircle the terminal assembly. Shield 130 is electrically and mechanically coupled to conductive housing 140 such that shield 130 may also be grounded. Shield 130, in conjunction with a spacer on insulator 120, may also serve to position the terminal assembly within the cavity and, in so doing, may establish signal to ground spacing for the electrical conductors within the terminal assembly. Such a configuration may provide a desired and stable impedance.

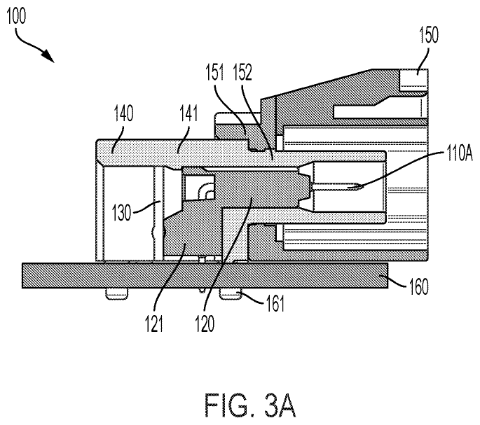

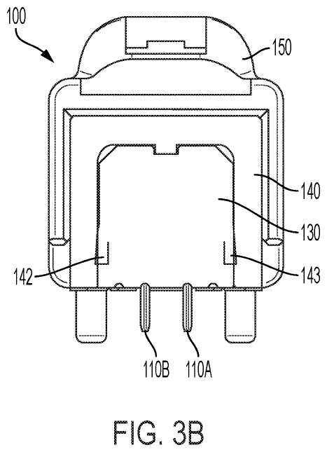

FIG. 3A is a sectional view of the illustrative board connector 100 of FIGS. 1 and 2, taken along the line 3A-3A in FIG. 2. As described herein, the board connector 100 includes insulator 120. The insulator may include a rib 121. The rib 121 may serve as a spacer, positioning the terminal assembly with respect to shield 130. The spacer may be sized and arranged to establish a designed separation between shield 130 and terminals 110A and 110B. The appropriate size and shape of the spacer may be determined based on a desired impedance. Shield 130 may contact one side of the rib 121.

As described herein, the insulator 120 and shield 130 may be engaged in conductive housing 140. Conductive housing 140 may include a retention feature 141 for preventing movement and absorbing force of the insulator 120. The retention feature 141 may be a rib configured to contact a wall of the insulator 120. Conductive housing 140 may further include a recess 152. The housing 150 may include a retention feature 151, which is configured to engage with the respective recess 152 of conductive housing 140.

FIG. 3B is a rear view of the board connector 100 of FIG. 3A, in accordance with some embodiments. The conductive housing 140 may also include retention features 142 and 143 for retaining shield 130.

Each of the contacts 110A and 110B may include one or more retention features configured to prevent movement of the contact in the insulator 120 of the connector 100. For example, the contact 110A includes a barb, configured to provide retention of the contact within the insulator. For example, insulator 120 may include a channel receiving each of the contacts 110A and 110B. The barb digs into the insulator at the side of the channel to firmly retain the contact. The channels are narrower proximate the barb and wider away from the barb.

In some embodiments, the barb and/or the width of the channel may appreciably impact impedance along contact 110A or 110B. Accordingly, the contact may be provided with an impedance compensation section proximate the retention feature. In this example, the impedance compensation section is formed by a narrowing portion.

In the illustrated embodiment, contacts 110A or 110B have the same shape. Accordingly, they may have the same retention features and same impedance compensation sections. It should also be appreciated that there may be more than one retention feature along the length of a contact 110A. Each retention feature, and the impedance compensating sections proximate the retention feature, may be similarly shaped. However, in some embodiments, the retention features along the length of a contact may have different sizes or different shapes.

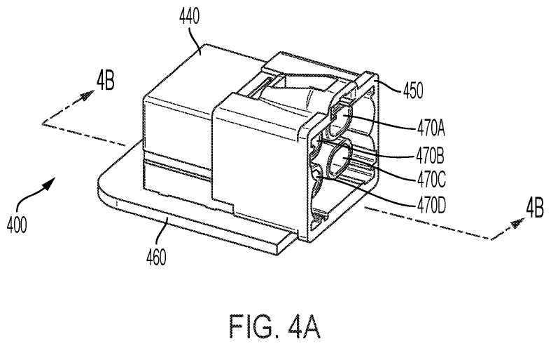

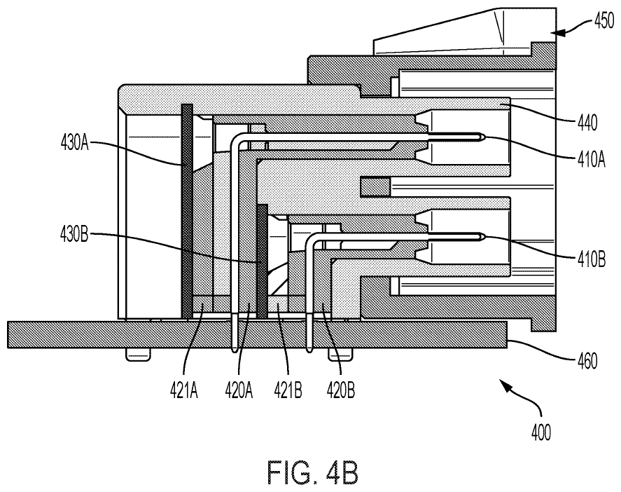

FIG. 4A is a perspective view of an illustrative multiport board connector 400, in accordance with some embodiments. For example, FIG. 4A shows a 2 by 2 connector 400 including 4 ports arranged in two rows of two ports. The conductive housing is shown with ports 470A-D, each of which is shaped and sized to receive a mating element therein. Each of the ports may have the same configuration as the mating portion 146 of board connector 100, such that the same mating elements may mate with either connector. As with board connector 100, conductive housing 440 is configured to be mounted to a board 460. An insulative housing 450, providing the same functionality as insulative housing 150 for a larger connector, is attached to conductive housing 440.

FIG. 4B illustrates a portion of the cross-sectional view along the line 4B-4B of FIG. 4A, in accordance with some embodiments. In the example of FIG. 4B, contacts in two of the ports are visible. As with connector 100, connector 400 has a pair of contacts in each port. In this example, the contacts in each port are held in a separate insulator, forming a terminal assembly for each of the ports. The insulators may have the same functions as described above for connector 100. For example, mating contact 410A is disposed in insulator 420A comprising a rib 421A. Mating contact 410B is disposed in insulator 420B comprising a rib 421B. Ribs 421A and 421B each positions its respective terminal assembly relative to a respective shield 430A and 430B. Each of the shields and insulators are engaged in the conductive housing 440, which is further disposed in an insulative housing 450.

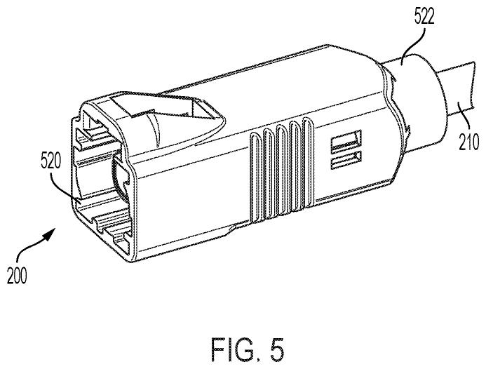

FIG. 5 is a perspective view of cable connector 200, in accordance with some embodiments. Cable connector 200 may have components analogous to those described above for board connector 100, including an outer insulative housing, an inner conductive housing that acts as a shield and a terminal assembly inside a cavity within the shield. The outer insulative housing, however, may have a mating interface and latching features that are complementary to those on board connector 100 such that cable connector 200 may mate with board connector 100. Likewise, an inner conductive housing may have a mating portion configured for mating with mating portion 146. Further, the terminal assembly, as well as other components, may be configured for terminating a cable rather than mounting on a printed circuit board. For example, the contacts may be electrically coupled to one or more conductors of a cable.

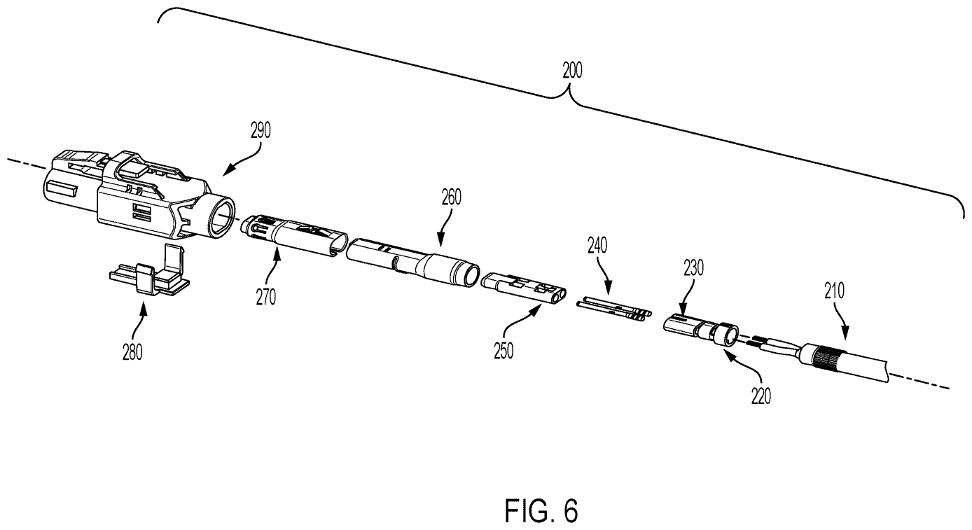

FIG. 6 is an exploded perspective view of an illustrative cable connector 200, in accordance with some embodiments. As illustrated in FIGS. 5 and 6, the illustrative cable connector 200 is configured to terminate cable 210. Cable connector 200 comprises a mating end 520 and a cable termination end 522 opposite the mating end. A cavity is open at the mating end 520. The connector terminates a cable at the cable termination end 522, where the cable has been manipulated to facilitate termination.

The bulk of the cable 210 may comprise one or more insulated conductors. In the example provided, the cable contains a pair of insulated conductors surrounded by a cable shield, which is then covered by an insulative jacket. The cable shield, for example, may be a braided shield or a conductive foil. For termination, the jacket may be removed, exposing the cable shield. The insulated conductors may be separated and at the distal ends, the insulator may be removed. For cables in which the insulated conductors are twisted together in the bulk cable, separating the insulated conductors may also involve untwisting the conductors. This manipulation of the cable enables the conductors of the insulated conductors to be attached to terminals of a connector. The cable shield may also be attached to a connector shield.

The cable connector 200 further includes ferrule 220 and impedance adaptor 230 which may be disposed around the cable 210. According to some embodiments, the impedance adaptor may be metal. The terminals 240 may be crimped to the conductors of the cable. The terminals may be a portion of a terminal assembly with an insulator, here illustrated as a contact carrier housing 250. The conductive inner housing of the cable connector may be formed from back and front shields 260 and 270, which may be electrically and mechanically coupled. The front shield 270 may include a mating interface and the rear shield 260 may be crimped to the cable and may be electrically coupled to the cable shield. These components may be at least partially enclosed in a cable connector housing 290.

The components 220, 230, 240, 250, 260 and 270 illustrated in FIG. 6 terminating the cable provide a contact carrier. In this example, the contact carrier is shielded. The position of the contact carrier within the housing may be secured using a contact carrier position assurance component (CCPA) 280.

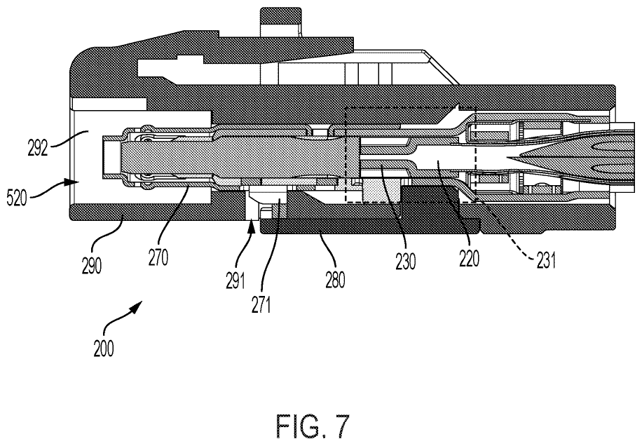

FIG. 7 is a sectional view of the illustrative cable connector of FIG. 6, in accordance with some embodiments. The impedance adaptor 230 is in the separated and/or untwisted area 231 of the cable termination. The area 231, where the cable has been manipulated, provides space to perform the crimping process of the contacts to the conductors of the cable. However, this manipulation of the cable modifies the impedance of the conductors. The metal is provided in proximity to the cable in order to provide a compensating change of impedance in the opposite direction. The impendence adaptor brings metal closer to the cable core. In the illustrated embodiments, the impedance adaptor will also be in contact with the back shield which connects the impedance adaptor to ground, establishing the signal to ground spacing for the conductors of the cable, which in turn establishes a desired impedance to match the impedance of the bulk cable. As used herein, impedances need not be identical to be matched. Rather, the impedances may be sufficiently close so as not to provide an impedance discontinuity that disrupts performance. For example, matched impedances may be within +/−5% or within +/−3 Ohms, in some embodiments.

To terminate cable 210, the cable end may be prepared for termination and inserted through ferrule 220 and impedance adapter 230. The cable shield may be folded over ferrule 220 and the conductors of cable 210 may be crimped to terminals 240. Terminals 240 may then be inserted into contact carrier housing 250. Back shield 260 may then be crimped around ferrule 220. Front shield 270 may then be engaged to back shield 260 and latched in place. These components may form a terminated cable assembly that is inserted into housing 290. The housing 290 may include an opening 292 to receive the terminated cable assembly.

The terminated cable assembly may be latched to housing 290, such as by latching a beam in the housing to a tab extending form one of the connectors shields. The housing 290, for example, may include a beam comprising a cantilevered end 291 and a latch at the cantilevered end 291 that extends into the opening 292. The latch may have camming surface 295 and the tab of the terminated cable assembly may have a forward edge that is tapered. As the terminated cable assembly is inserted into housing 290, the tapered surface of the tab may engage the camming surface of latch, forcing latch upwards, until the rear edge of the tab clears the camming surface. In that position, the spring force in deflected beam will push the beam downwards, latching the tab in place.

FIG. 7 illustrates a connector with one contact carrier held in an insulative housing. Such a connector may be configured to mate with a single port board connector, such as is illustrated in FIG. 1. A plug connector may be constructed to mate with a multiport connector, such as is illustrated in FIG. 4A, by incorporating multiple contact carriers within an insulative housing.

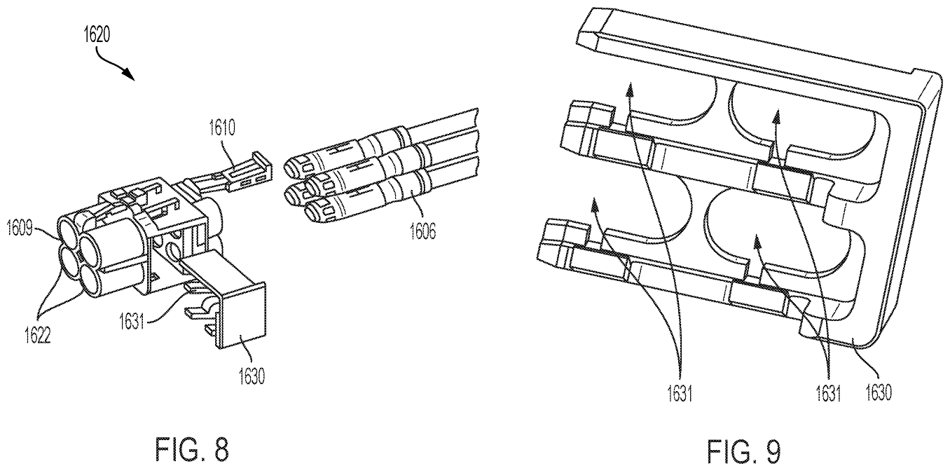

FIG. 8 is a perspective, exploded view of an illustrative unsealed multi-port cable connector, here configured as a plug, which may mate with a board connector as shown in FIG. 4A or other connector with a similar mating interface. The illustrative unsealed cable connector 1620 shown in FIG. 8 comprises an insulative housing 1609 including four chambers 1622 arranged in a 2×2 matrix, each chamber receiving a contact carrier 1606. Each contact carrier 1606 may have a configuration as described above in connection with FIG. 6.

The unsealed contact carrier connector 1620 may also comprise a contact carrier position assurance component 1630. In this example, contact carrier position assurance component 1630 enables simple and reliable assembly of a cable connector with multiple contact carriers. For example, it may be latched to insulative housing 1609 in an open position in which multiple contact carriers may be inserted into housing 1609. If those contact carriers are properly seated in insulative housing 1609, contact carrier position assurance component 1630 may be slid into a closed position through application of a force that overcomes the latching. Latching features on the contact carrier position assurance component 1630 may snap into place when the contact carrier position assurance component 1630 reaches the closed position and may provide audible and/or tactile feedback to a user that the contact carriers are properly seated in insulative housing 1609. Conversely, if one or more of the contact carriers are out of position, the contact carrier position assurance component 1630 may not slide or may require application of a large amount of force, above a threshold that would be noticed by a user, to slide. In this way, a user (which may be a human or an assembly machine), may quickly secure multiple contact carriers within the housing or determine that one or more are not properly seated.

FIG. 9 is a perspective view of an illustrative contact carrier position assurance component 1630. In this example, contact carrier position assurance component 1630 is configured for securing four contact carriers simultaneously. The contact carrier position assurance component 1630 of FIG. 9 may comprise four openings 1631 arranged in a 2×2 matric, each opening receiving a contact carrier 1606 when the contact carrier position assurance component 1630 is inserted within the insulative housing 1609.

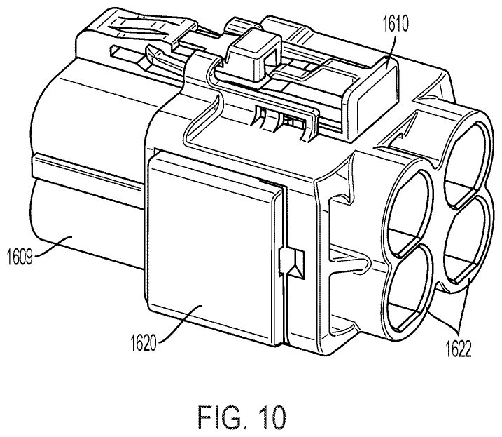

FIG. 10 is a perspective view of a housing subassembly of the illustrative unsealed multi-port cable connector 1620 of FIG. 8. In this state, contact carrier position assurance component 1630 is inserted within the insulative housing 1609. Either or both of insulative housing 1609 and contact carrier position assurance component 1630 may include one or more latching features and/or one or more complementary latching features such that contact carrier position assurance component 1630 may be latched with respect to the housing.

In some examples, contact carrier position assurance component 1630 may include a latching feature and insulative housing 1609 may have two complementary latching features such that contact carrier position assurance component 1630 may be latched in two positions relative to insulative housing 1609. FIG. 10 shows contact carrier position assurance component 1630 latched in a first such position. In the illustrated state, contact carrier position assurance component 1630 is in an open state such that contact carriers may be inserted through the openings 1631 into chambers 1622.

One or more additional components optionally may be integrated into the connector housing subassembly. A connector position assurance component 1610, for example, may be attached to housing 1609.

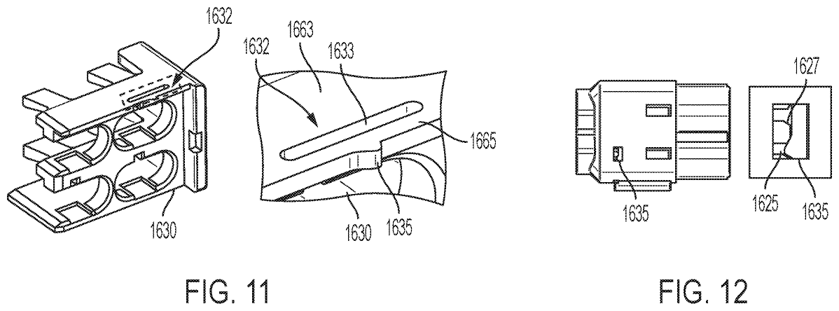

FIG. 11 is a perspective view of the illustrative contact carrier position assurance component 1630 of FIG. 9 showing a latch 1632 that is configured to engage with a complementary latching feature of the insulative housing 1609 when the position assurance component 1630 is at one or more predetermined positions within the insulative housing 1609. The contact carrier position assurance component 1630 of FIG. 9 may comprise a body 1663. Latch 1632 of the contact carrier position assurance component 1630 may comprise a member 1665 separates from body 1663 by slit 1633. The latch 1632 of the contact carrier position assurance component 1630 may further comprise a protrusion 1635 on the member 1665. The member 1665 may be elongated in a direction between a first end and a second end, and the member 1665 may be attached to the body 1663 at the first end and the second end. The member 1665 may comprise a central portion between the first end and the second end and the protrusion 1635 may extend from the central portion. Contact carrier position assurance component 1630 may be molded from plastic such that member 1665 is integral with body 1663.

Member 1665 may be compliant. When protrusion 1635 presses against a surface of housing 1609, the central portion of member 1665 may be pushed into slot 1633 such that protrusion 1635 does not interfere with contact carrier position assurance component 1630 sliding relative to the housing. However, when protrusion 1635 aligns with a rut in the surface of the housing, member 1665 may spring away from body 1663, forcing protrusion 1635 into the rut. This action may provide tactile and/or audible feedback to a user indicating that the contact carrier position assurance component 1630 is in a position established by the relative position of the protrusion and the rut. Additionally, engagement of protrusion 1635 and a rut may restrain motion of contact carrier position assurance component 1630 relative to the housing 1609 until a sufficient force is applied to contact carrier position assurance component 1630 to overcome the restraint by forcing member 1665 to deflect into slot 1633.

FIG. 12 is a side view of the illustrative unsealed multi-port cable connector of FIG. 8 showing the contact carrier position assurance component 1630 in an open position within insulative housing 1609. The complementary latching feature of the insulative housing 1609 comprises a first rut 1625, which is configured to engage with the protrusion 1635 on the member 1665 of the contact carrier position assurance component 1630 to hold the contact carrier position assurance component 1630 in an open position within the insulative housing 1609.

As shown in FIG. 12, the insulative housing 1609 may also comprise a second rut 1627, which is configured to engage with the protrusion 1635 on the member 1665 of the contact carrier position assurance component 1630 to hold the contact carrier position assurance component 1630 in a closed position within the insulative housing 1609.

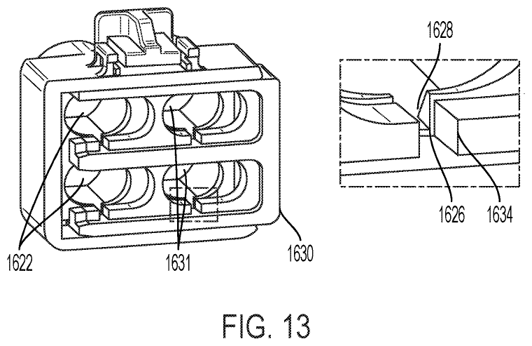

FIG. 13 is a sectional view of the illustrative housing subassembly of FIG. 10. In the state illustrated, contact carrier position assurance component 1630 is latched in the open position. As shown by FIG. 13, the contact carrier position assurance component 1630 may comprise one or more openings 1631. In this example, the contact carrier position assurance component 1630 has four openings 1631 arranged in a 2×2 matrix. As also shown by FIG. 13, the insulative housing 1609 may comprise one or more chambers 1622. An opening 1631 of contact carrier position assurance component 1630 may align with each of the chambers 1622. In this example, the four chambers 1622 of the insulative housing 1609 are arranged in a 2×2 matrix. Optionally, the four chambers 1622 of the insulative housing 1609 correspond with four respective openings 1631 of the contact carrier position assurance component 1630.

Contact carrier position assurance component 1630 and housing 1609 may be collectively configured such that a contact carrier may be inserted through an opening 1631 into a chamber 1622 when contact carrier position assurance component 1630 is in the open position but cannot be withdrawn when contact carrier position assurance component 1630 is slid into a closed position. In the illustrated example, a contact carrier may have a projecting feature that can pass through a channel in contact carrier position assurance component 1630 when contact carrier position assurance component 1630 is in the open position but is blocked from being withdrawn from the opening when contact carrier position assurance component 1630 slides into the closed position.

As shown by FIG. 13, the contact carrier position assurance component has a channel 1626, and a wall 1634, which bounds the channel 1626. Optionally, the insulative housing 1609 comprises a channel 1628. When contact carrier position assurance component 1630 is in the open position, channel 1628 of the insulative housing 1609 may align with the channel 1626 of the contact carrier position assurance component 1630. In this state, contact carrier 1606 with its tab 1611 may slide through the opening 1631 of contact carrier position assurance component 1630 and into chamber 1622 of the insulative housing 1609 as explained in detail below.

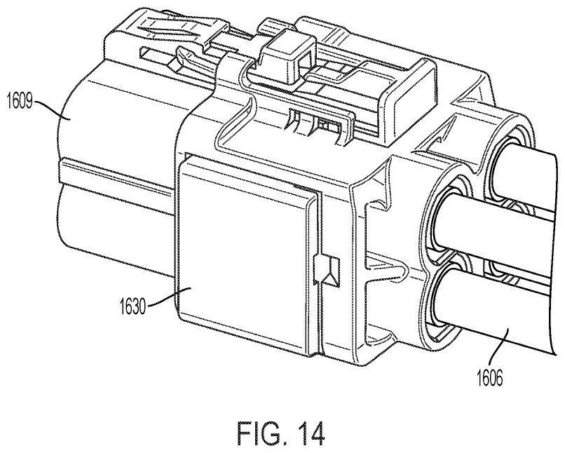

FIG. 14 is a perspective view of the illustrative unsealed multi-port cable connector of FIG. 8, with the contact carriers 1606 and contact carrier position assurance component 1630 inserted within the housing subassembly of FIG. 10. In FIG. 14, contact carrier position assurance component 1630 is in the open position. In this example, it can be seen that an exterior surface of contact carrier position assurance component 1630 extends beyond a surface of housing 1609.

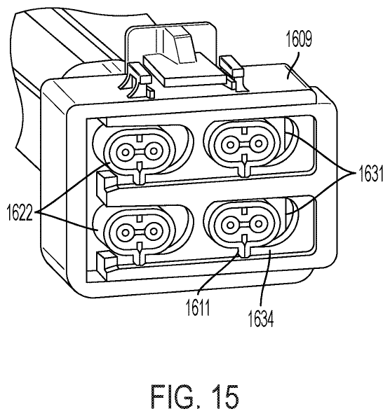

FIG. 15 is a sectional view of the illustrative unsealed multi-port cable connector of FIG. 14. FIG. 15 shows the contact carrier position assurance component 1630 inserted into the insulative housing 1609 so that the openings 1631 of the contact carrier position assurance component 1630 align with the chambers 1622 of the insulative housing 1609. FIG. 15 also shows the contact carriers 1606 inserted into the chambers 1622 of the insulative housing 1609 through the openings 1631 of the contact carrier position assurance component 1630. The tab 1611 on a contact carrier 1606, the channel 1628 on the insulative housing 1609, and the channel 1626 on the contact carrier position assurance component 1630 align to enable the tab 1611 on the contact carrier 1606 to pass through the channel 1628 on the insulative housing 1609 and the channel 1626 of the contact carrier position assurance component 1630. In this state, the contact carrier 1606 may be inserted into the chamber 1622 of the insulative housing 1609 through the opening 1631 of the contact carrier position assurance component 1630. As shown, the contact carrier when inserted sufficiently far into the chamber that it is in its designed position, a rear edge of tab 1611 extends beyond a forward surface of wall 1634.

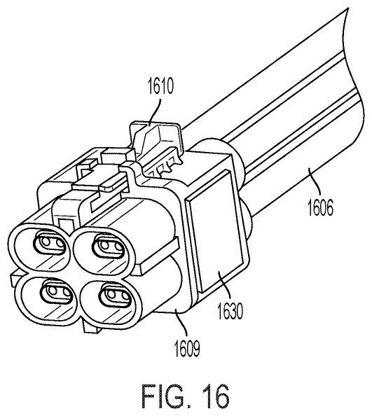

FIG. 16 is a perspective view of the illustrative unsealed multi-port cable connector of FIG. 14, showing the contact carriers 1606 inserted into the respective chambers 1622 of the insulative housing 1609 and the contact carrier position assurance component 1630 slid into a closed position within the insulative housing 1609. In this example, it can be seen that, in contrast with the position of FIG. 14, an exterior surface of contact carrier position assurance component 1630 is substantially flush with a surface of housing 1609.

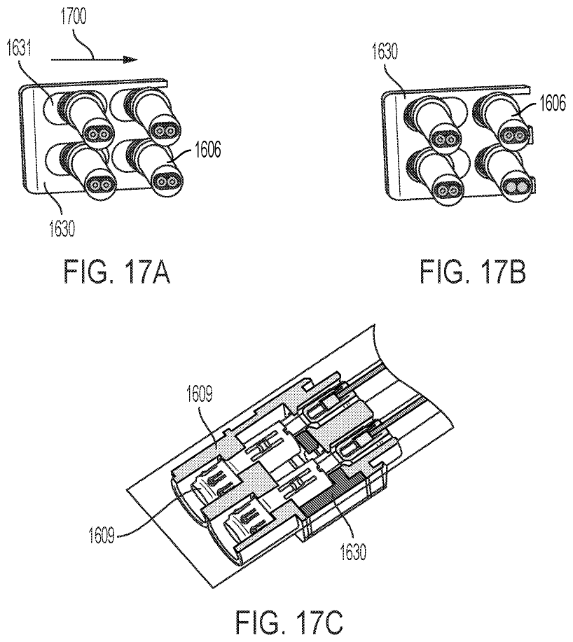

FIG. 17A is a rear view of the illustrative contact carrier position assurance component 1630 of FIG. 9 and the contact carriers 1606 in an open position in an electrical connector 1620. Arrow 1700 illustrates the direction of sliding contact carrier position assurance component 1630 from an open position to a closed position. In this example, the direction of sliding 1700 is orthogonal to the direction of insertion of the contact carriers into housing 1609. FIG. 17B is a rear view of the illustrative contact carrier position assurance component 1630 and the contact carriers 1606 of FIG. 17A, with the contact carrier position assurance component 1630 slid into a closed position in an electrical connector 1620.

In this example, openings 1631 are wider, in the sliding direction, than the portions of contact carriers 1606 within the openings 1631. This additional width enables contact carrier position assurance component 1630 to slide within housing 1609 with the contact carriers inserted in the openings 1631.

In the state illustrated in FIG. 17A, tab 1611 (see, FIG. 15) extends beyond wall 1634, but is aligned with the channel 1626. With contact carrier position assurance component 1630 slid into the closed position shown in FIG. 17B, tab 1611 aligns with a forward surface of wall 1634, such that wall 1634 blocks withdrawal of the contact carrier from the chamber 1622.

FIG. 17C is a top sectional view of the illustrative unsealed multi-port cable connector, with the contact carriers 1606 and contact carrier position assurance component 1630 inserted within the insulative housing 1609 of the electrical connector 1620. FIGS. 17A, 17B, and 17C illustrate a method of operating the electrical connector during which the contact carriers 1606 are inserted into the insulative housing 1609 of the electrical connector 1620 through openings of the contact carrier position assurance component 1630, with the contact carrier position assurance component 1630 initially in an open position and then in a closed position.

In an exemplary method, the contact carrier position assurance component 1630 is disposed in an open position at least partially within the insulative housing 1609 such that the chambers 1622 of the insulative housing 1609 align with respective openings 1631 of the contact carrier position assurance component 1630. In this open position, the channel 1628 of the insulative housing 1609 is also aligned with the channel 1626 of the contact carrier position assurance component 1630. The contact carrier 1606 is inserted through an opening 1631 of the contact carrier position assurance component 1630 into a chamber 1622 of the insulative housing 1609 by aligning the tab 1611 of the contact carrier 1606 with the channel 1628 of the insulative housing 1609 and the channel 1626 of the contact carrier position assurance component 1630. Next, the contact carrier position assurance component 1630 is slid relative to the insulative housing 1609 such that the channel 1628 of the insulative housing 1609 is blocked by the contact carrier position assurance component.

Optionally, the contact carrier position assurance component 1630 may be slid relative to the insulative housing 1609 by pushing the contact carrier position assurance component 1630 until its protrusion 1635 engages with the first rut 1625 of the insulative housing 1609 to secure and hold the contact carrier position assurance component 16 30 in the open position. The housing and contact carrier position assurance component 1630 in this state may form a housing subassembly. After the contact carrier 1606 is inserted through an opening 1631 of the contact carrier position assurance component 1630 into a chamber 1622 of the insulative housing 1609 (e.g., by aligning the tab 1611 of the contact carrier 1606 with the channel 1628 of the insulative housing 1609 and the channel 1626 of the contact carrier position assurance component 1630 as described above), the contact carrier position assurance component 1630 may be slid further relative to the insulative housing 1609 by pushing the contact carrier position assurance component 1630 further until its protrusion 1635 engages with the second rut 1627 of the insulative housing 1609. In this second position, the contact carrier position assurance component may be in a closed position within the insulative housing 1609.

If the contact carrier is fully inserted into the insulative housing, tab 1611 will be forward of wall 1634 and contact carrier position assurance component 1630 may slide relatively easily from the open position to the closed position. A first force, above a first threshold, may be required to overcome the retention of the latch of the contact carrier position assurance component 1630 within the first rut. However, this first force may be less than a second force required to move contact carrier position assurance component 1630 into a closed position if the contact carrier is not positioned in the designed location. If the contact carrier is not fully inserted, tab 1611 may interfere with wall 1634, blocking easy sliding motion of the contact carrier position assurance component 1630 into the closed position. In some scenarios, the amount of force required to slide contact carrier position assurance component 1630 may exceed the force that can easily be generated by a person or may otherwise be so high that a user may recognize that one or more contact carriers are mispositioned.

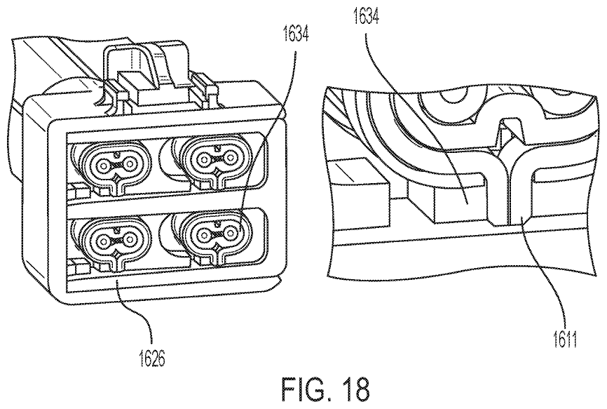

FIG. 18 is a front sectional view of the illustrative multi-port cable connector 1620 of FIG. 14 with the contact carriers 1606 in their designed positions and contact carrier position assurance component 1630 secured in the closed position. In the closed position, the rear edge of tab 1611 of the contact carrier 1606 faces a surface of wall 1634 of the contact carrier position assurance component 1630 such that the surface interferes with withdrawal of the tab 1611 of the contact carrier 1606 through the channel of the insulative housing 1609.

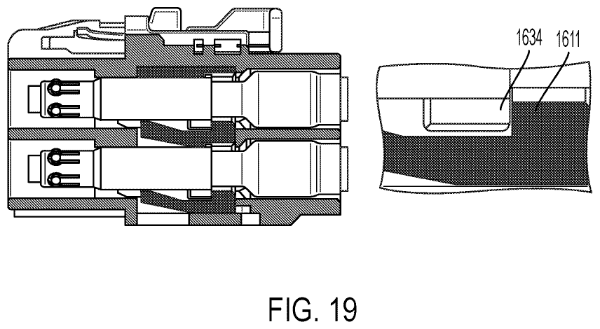

FIG. 19 is a sectional view of the illustrative multi-port cable connector 1620 of FIG. 16 showing positioning of the contact carriers 1606 within the insulative housing 1609 by the tab 1611 on the contact carrier 1606 when contact carrier position assurance component 1630 is in the closed position. FIG. 19 also shows the surface of the wall 1634 of the contact carrier position assurance component 1630 blocking withdrawal of the tab 1611 of the contact carrier 1606 through the channel of the insulative housing 1609.

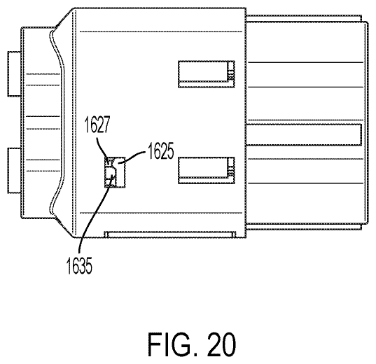

FIG. 20 is a side view of the illustrative unsealed multi-port cable connector 1620 of FIG. 16 showing the contact carrier position assurance component 1630 in the closed position within the insulative housing 1609. The protrusion 1635 on the member 1665 of the body 1663 of the contact carrier position assurance component 1630 is engaged with the second rut 1627 of the insulative housing 1609 to secure the contact carrier position assurance component 1630 in the final position within the insulative housing 1609.

In other embodiments, a contact carrier position assurance component may slide from an open position to a closed position in a direction parallel to the direction of insertion of contact carriers into a connector housing. Such a configuration may enable integration of one or more seals into the connector. Moreover, a direction of sliding parallel to the direction of insertion of contact carriers may enable the contact carrier position assurance component to be inserted into the connector housing through the same opening in the connector housing as the contact carriers, reducing the number of openings that must be sealed to provide a sealed connector.

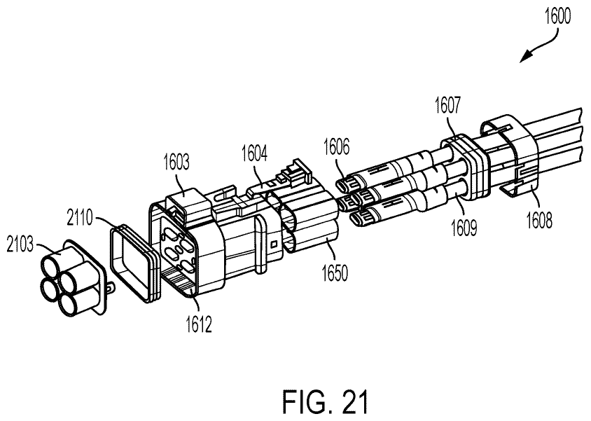

FIG. 21 is a perspective, exploded view of an illustrative sealed multi-port cable connector 1600. In this example, the cable connector is assembled from one or more contact carriers 1606, as described above. The mating interface of the sealed connector may be the same as the unsealed cable connector, and may be, for example, as shown in FIG. 16.

The illustrative sealed cable connector 1600 shown in FIG. 21 comprises a two-piece insulative housing, comprising a main housing 1603 and a front housing 2103. Such a configuration facilitates installing ring seal 2110 within main housing 1603 around the mating interface. Ring seal 2110 may be positioned to engage with a mating connector and seal the interface between the cable connector and the mating connector.

The insulative housing in this example includes four chambers 1612 arranged in a 2×2 matrix, each chamber receiving a contact carrier 1606. The sealed contact carrier connector 1600 may also comprise one or more contact carrier position assurance components. In this example, two contact carrier position assurance components 1650A and 1650B may together form contact carrier position assurance component 1650. Forming the contact carrier position assurance component 1650 as multiple pieces may enable strengthening walls or ribs within the connector housing between the separate pieces. On the other hand, forming the contact carrier position assurance component 1650 with multiple openings per piece may simplify assembly and facilitate properly seating of each piece within the connector housing. Accordingly, one piece per row or column of contact carriers in the connector may provide both enhanced manufacturability and ruggedness of the finished connector. In this example, the contact carrier position assurance component is formed in two pieces, one for each column in a 2×2 connector. Such a configuration may contribute to the modularity of the connector system, as the same the contact carrier position assurance component may be used to construct a 1×2 connector as is used for this 2×2 connector. Likewise, the same component may be used for connectors of other sizes, such as a 4×4 connector.

In the example of FIG. 21, contact carrier position assurance component 1650 may be inserted into housing 1603 when the cable connector is assembled. Optionally, the insulative housing 1603 may be pre-assembled into a housing subassembly. with the contact carrier position assurance component 1650 inserted within the insulative housing 1603. In such a configuration, contact carrier position assurance component 1650 may be latched to insulative housing 1603, such as by using latching features and complimentary latching features, as described above.

The illustrative sealed contact carrier connector 1600 may also comprise a cable seal 1607 having one or more openings 1609. The openings 1609 of the seal 1607 may be aligned with the chambers 1612 of the insulative housing 1603. The illustrative sealed contact carrier connector 1600 may also comprise a cover 1608. Cover 1608, when installed, may engage with main housing 1603, such as through latches or other engagement features. Cover 1608 may cover the cable seal 1607 and may retain it within main housing 1603 and/or protect it from physical damage and the like. Optionally, the cover 1608 may be configured to press the seal 1607 against the contact carrier position assurance component 1650. In some embodiments, when the contact carriers are positioned in a designed location within the connector housing, cover 1608 may press onto the housing with a force that is below a threshold. In contrast, if the contact carriers are not positioned in the designed location, the contact carrier position assurance component 1650 may not readily slide into its closed position, and a larger force, above a second threshold may be required to press the cover 1608 in place, providing feedback to an installer, whether a person or machine, that the components inside the connector housing are not positioned in their designed locations.

The illustrative sealed cable connector 1600 may also comprise a connector position assurance component 1604.

The illustrative contact carrier position assurance component 1650 of FIG. 21 has four openings 1652 arranged in a 2×2 matrix, each opening receiving a contact carrier 1606 when the contact carrier position assurance component 1650 is inserted within the insulative housing 1603.

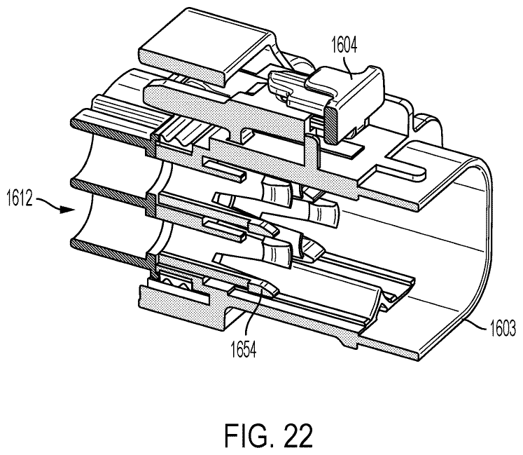

FIG. 22 is a sectional view of a portion of the illustrative multi-port contact carrier connector 1600 of FIG. 21 showing the insulative housing 1603. The insulative housing may also comprise a latch 1654 adjacent to each chamber 1612.

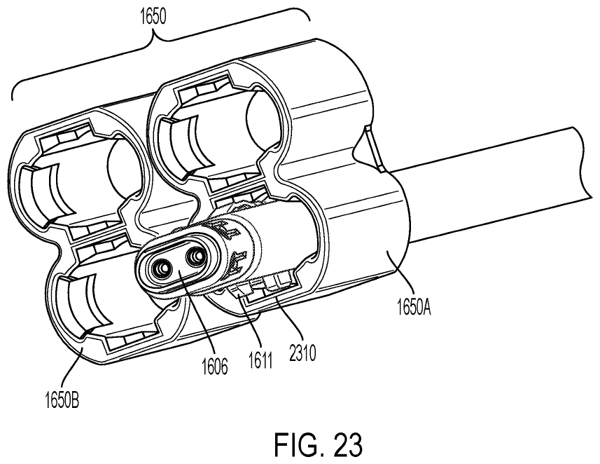

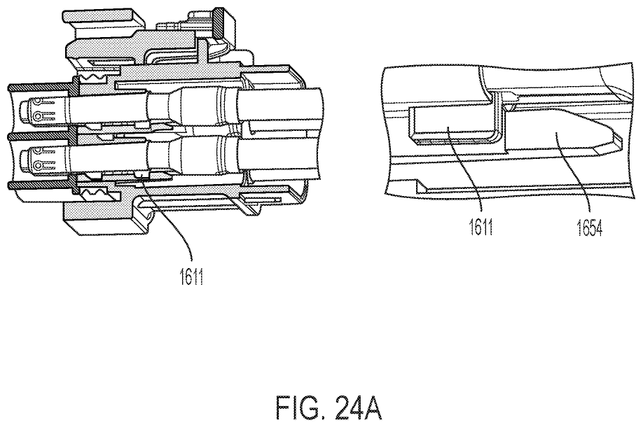

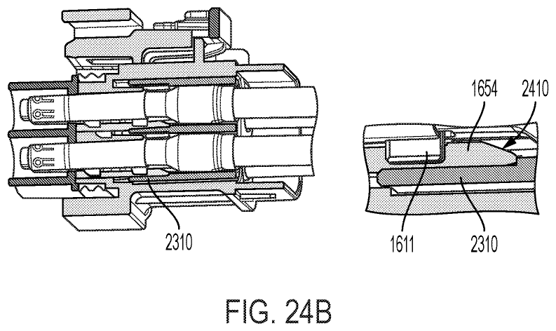

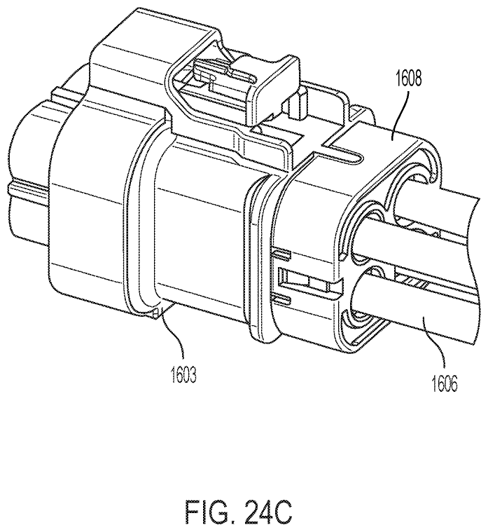

FIG. 23 is a perspective view of the illustrative sealed multi-port cable connector 1600 of FIG. 21, shown in phantom, with a contact carrier 1606 inserted into the insulative housing 1603. The contact carrier position assurance component 1650 may comprise a body with one or more openings therethrough, and a projecting member 2310 adjacent each opening. Optionally, the contact carrier position assurance component 1650 may have slots 2410 (FIG. 24B) separating the projecting members from the body. FIG. 23 illustrates the relative position of contact carrier position assurance component 1650 and a contact carrier 1606 with the contact carrier position assurance component 1650 in an open position.

FIG. 24A is a sectional view of the illustrative sealed multi-port cable connector 1600 of FIG. 21 showing positioning of the contact carrier 1606 within the insulative housing 1603 by a primary latch 1654. In the illustrated state, the primary latch 1654 of the insulative housing 1603 engages a tab 1611 of the contact carrier 1606 to retain the contact carrier 1606 in a position within the chamber 1612 of the insulative housing 1603. In the example illustrated, latch 1654 comprises a flexible beam with a hooked end that engages a rearward edge of tab 1611. When latch 1654 is engaged with tab 1611, latch 1654 will block motion of tab 1611 in a direction that would withdraw the contact carrier from the housing.

In the state illustrated in FIG. 24A, contact carrier position assurance component 1650 is in an open position, and is not visible in FIG. 24A. Optionally, the contact carrier position assurance component 1650 is slidably disposed within the insulative housing 1603, such that it may slide into the closed position. For example, installing cover 1608 may apply a force on contact carrier position assurance component 1650, forcing it to slide into the position illustrated.

FIG. 24B is a sectional view of the illustrative sealed multi-port cable connector 1600 of FIG. 21 showing the contact carrier position assurance component 1650 in a closed position. In this position, projection 2310 blocks the primary latch 1654. Optionally, the contact carrier positional assurance component 1650 may include a slot 2410 such that the primary latch 1654 is disposed within a slot 2410 of the contact carrier position assurance component 1650 to restrain motion of the primary latch 1654 when contact carrier position assurance component 1650 is in a closed position. The primary latch 1654 is restrained in the position in which it is engaged with tab 1611. As illustrated, projection 2310 blocks motion of primary latch 1654 away from tab 1611. FIG. 24C is a perspective view of the illustrative sealed multi-port cable connector 1600 of FIG. 21 with a cover 1608 installed. The sealed multi-port cable connector 1600 is configured to mate with a mating connector in an insertion direction and the contact carrier position assurance component 1650 is configured to slide into the housing in the insertion direction. In the assembled state, cables connected to the contact carriers 1606 extend through openings 1609 of the seal 1607 and openings of the cover 1608.

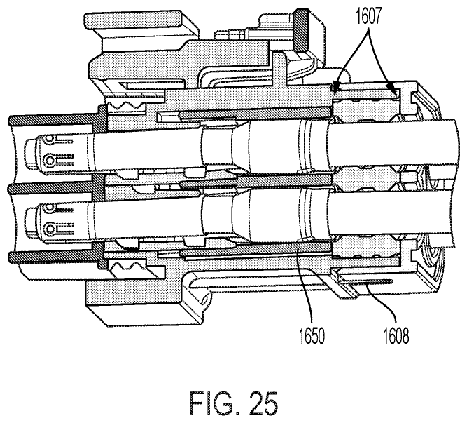

FIG. 25 is a sectional view of the illustrative sealed multi-port cable connector 1600 of FIG. 24C showing the seal 1607 and cover 1608 blocking the contact carrier position assurance component 1650. The configurations illustrated in the figures for the sealed multi-port cable connector (e.g., FIGS. 21-25) result from a method of constructing the connector. In an exemplary method, cover 1608 and seal 1607 may be threaded onto cables to be terminated by contact carriers 1606. The contact carriers may then be attached.

The contact carriers 1606 may then be inserted into openings of contact carrier position assurance component 1650 and slid into the chambers 1612 of the insulative housing 1603 until tabs 1611 on the contact carrier 1606 engage respective primary latches 1654 of the insulative housing 1603. Next, the contact carrier position assurance component 1650 may be slid forward in the insulative housing 1603 until a portion of the contact carrier position assurance component 1650 is adjacent each of the latches 1654 on the insulative housing, blocking motion of the latches in a direction that would disengage the latch from a contact carrier. Optionally, a distal end of each of the latches may be disposed in a slot of the contact carrier position assurance component 1650.

The force sliding the contact carrier position assurance component 1650 into the closed position may be generated by pushing cover 1608 toward the insulative housing 1603. Such a pushing action may urge the seal 1607 against the contact carrier position assurance component 1650. Optionally, a mispositioning of the contact carrier 1606 may be detected when the magnitude of the force with which the cover 1608 is pushed toward the insulative housing 1603 exceeds a threshold but the cover 1608 does not engage the insulative housing 1603.

Having thus described several aspects of at least one embodiment of this invention, it is to be appreciated that various alterations, modifications, and improvements will readily occur to those skilled in the art.

For example, the contact carrier position assurance component 1650 may include latching features to engage a connector housing in an open and/or closed position.

As another example, techniques described herein may be used in connectors having configurations other than those described above. For example, techniques described herein may be used in board connector or a right-angle cable connector, for example. Moreover, features of a position assurance component described in connection with a sealed connector may be used in an unsealed connector instead of or in addition to features described in connection with the unsealed connector. Similarly, features of a position assurance component described in connection with an unsealed connector may be used in a sealed connector instead of or in addition to features described in connection with the sealed connector.

Such alternative connector configurations may be used with all of the features described herein or a subset of any suitable number of features. Moreover, it should be appreciated that all of the structures, materials and construction techniques described herein may be used together, but, in some embodiments, some or all of the structures, materials or techniques may be omitted.

Such alterations or modifications are intended to be part of this disclosure and are intended to be within the spirit and scope of the invention. Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

### EXAMPLES

In a first example, an electrical connector, may comprise: an insulative housing comprising a chamber and a channel; a position assurance component comprising an opening having a channel and a surface adjacent the channel; and a contact carrier comprising a tab; wherein, the position assurance component is slidably mounted in the insulative housing and configured to slide between an open position in which the channel of the insulative housing, the channel of the position assurance component, and the tab on the contact carrier align and a closed position in which the surface of the position assurance component aligns with the channel of the insulative housing.

Optionally, the position assurance component has a wall bounding the channel; the surface comprises one end of the wall; and the position assurance component is in the closed position such that the surface interferes with withdrawal of the tab of the contact carrier through the channel.

Optionally, the position assurance component comprises a latching feature comprising a slit; and the insulative housing comprises a complementary latching feature, complementary to the latch of the position assurance component and configured to engage the latching feature when the position assurance component is at a predetermined position within the insulative housing.

Optionally, the position assurance component comprises a body; the latching feature comprises a member; the slit separates the member from the body; and the latching feature comprises a protrusion on the member.

Optionally, the member is elongated in a direction between a first end and a second end; and the member is attached to the body at the first end and the second end.

Optionally, the member comprises a central portion between first end and the second end; and the protrusion extends from the central portion.

Optionally, the complementary latching feature comprises a rut configured to engage with at least a portion of the latching feature of the position assurance component so as to hold the position assurance component in the predetermined position within the insulative housing.

Optionally, the rut is a first rut; the predetermined position is a first predetermined position; the insulative housing comprises a second rut; the second rut is configured to engage the latching feature when the position assurance component is in a second predetermined position within the insulative housing.

Optionally, the electrical connector comprises a plurality of contact carriers wherein: the insulative housing comprises a plurality of chambers; and the position assurance component comprises a plurality of openings.

Optionally, the electrical connector comprises four contact carriers wherein: the insulative housing comprises four chambers; and the position assurance component comprises four openings.

In a second example, an electrical connector, may comprise: an insulative housing comprising a chamber; a position assurance component comprising an opening and a surface; and a contact carrier having a tab and being positioned within the chamber; wherein: the contact carrier extends through the opening of the position assurance component; and the position assurance component is positioned such that the surface interferes with the tab of the contact carrier so as to prevent the contact carrier from being withdrawn from the chamber of the insulative housing and the opening in the position assurance component.

Optionally, the position assurance component comprises a protrusion; and the insulative housing comprises a first rut, the tab of the position assurance component resting within the first rut of the insulative housing to hold the position assurance component in a first position with the insulative housing.

Optionally, the insulative housing comprises a second rut, the protrusion of the position assurance component resting within the second rut of the insulative housing to hold the position assurance component in a second position with the insulative housing.

Optionally, the electrical connector further comprises a plurality of contact carriers, including the contact carrier, wherein: the insulative housing comprises a plurality of chambers, including the chamber; the position assurance component comprises a plurality of openings, including the opening.

Optionally, the electrical connector comprises four contact carriers wherein: the insulative housing comprises four chambers; and the position assurance component comprises four openings.

Optionally, the four openings of the position assurance component are arranged as a two-by-two matrix.

In a third example, a housing subassembly for an electrical connector, may comprise: an insulative housing comprising a chamber having a channel; a position assurance component comprising an opening having a channel and a surface adjacent the channel; and wherein, the position assurance component is slidably mounted in the insulative housing to slide between an open position in which the channel of the insulative housing and the channel of the position assurance component align and a closed position in which the surface of the position assurance component aligns with the channel on the insulative housing; the position assurance component comprises a latch configured to engage a complementary structure in the insulative housing when the position assurance component is in the open position.

Optionally, the position assurance component comprises a body and a slit; the latching feature comprises a member; the slit separates the member from the body; and the latching feature comprises a protrusion on the member.

Optionally, the member is elongated in a direction between a first end and a second end; and the member is attached to the body at the first end and the second end.

Optionally, the member comprises a central portion between first end and the second end; and the protrusion extends from the central portion.

Optionally, the complementary latching feature comprises a rut configured to engage with at least a portion of the latching feature of the position assurance component so as to hold the position assurance component in the predetermined position within the insulative housing.

Optionally, the rut is a first rut; the predetermined position is a first predetermined position; the insulative housing comprises a second rut; the second rut is configured to engage the latching feature when the position assurance component is in a second predetermined position within the insulative housing.

Optionally, the electrical connector subassembly further comprises four contact carriers wherein: the insulative housing comprises four chambers; and the position assurance component comprises four openings.

Optionally, the four openings of the position assurance component are arranged as a two-by-two matrix.

In a fourth example, a method of operating an electrical connector comprising an insulative housing comprising a chamber and a channel, a position assurance component comprising an opening having a channel and a surface adjacent the channel, and a contact carrier comprising a tab, may comprise: with the position assurance component disposed at a first position at least partially within the insulative housing such that the channel of the insulative housing is aligned with the channel of the position assurance component, inserting the contact carrier through the opening of the position assurance component into the chamber of the insulative housing by aligning the tab of the contact carrier with the channel of the insulative housing and the channel of the position assurance component; and sliding the position assurance component relative to the insulative housing such that the channel of the insulative housing is blocked by the position assurance component.

Optionally, the position assurance component further comprises a protrusion and the insulative housing comprises a first rut, the method further comprising: pushing the position assurance component until the protrusion engages with the first rut of the insulative housing to secure the position assurance component in an open position within the insulative housing, whereby the position assurance component is held at the first position.

Optionally, the insulative housing comprises a second rut, wherein: sliding the position assurance component relative to the insulative housing comprises pushing the position assurance component until the protrusion engages with the second rut to secure the position assurance component in a final position within the insulative housing.

In a fifth example, an electrical connector may comprise: an insulative housing comprising a chamber and a latch adjacent to the chamber; a position assurance component comprising a body with an opening therethrough, a projecting member, and a slot separating the projecting member from the body; and a contact carrier having a tab extending through the opening of the position assurance component and disposed within the chamber of the insulative housing; wherein the latch of the housing engages the tab of the contact carrier so as to retain the contact carrier in a position within the chamber and the position assurance component is positioned such that the latch is disposed within the slot such that motion of the latch is restrained.

Optionally, the electrical connector may further comprise: a seal having an opening, wherein the opening of the seal is aligned with the chamber of the insulative housing.

Optionally, the insulative housing comprises a cover; the cover is configured to press the seal against the position assurance component.

Optionally, the position assurance component is slidably disposed within the insulative housing.

Optionally, the electrical connector is configured to mate with a mating connector in an insertion direction; and the position assurance component is configured to slide within the insulative housing in the insertion direction.

Optionally, the insulative housing comprises a cover for the seal, the cover having an opening; the electrical connector further comprises a cable connected to the contact carrier; and the cable extends through the opening of the seal and the opening of the cover.

Optionally, the electrical connector comprises a plurality of contact carriers, including the contact carrier; the insulative housing comprises a plurality of chambers, including the chamber; the position assurance component comprises a plurality of openings, including the opening; and the seal comprises a plurality of openings, including the opening.

Optionally, the plurality of contact carriers is four contact carriers, the plurality of chambers in the insulative housing is four chambers; the position assurance component is a first position assurance component and plurality of openings is two openings; the electrical connector comprises a second position assurance component comprising two openings; and the plurality of openings of the seal is four openings.

In a sixth example, a method of operating an electrical connector comprising an insulative housing comprising a chamber and a latch adjacent to the chamber, a position assurance component comprising a body with an opening therethrough, a projecting member, and a slot separating the projecting member from the body, may comprise:
sliding the contact carrier into the chamber of the insulative housing until the tab of the contact carrier engages the latch of the housing; and sliding the position assurance component into the insulative housing until the projecting member of the position assurance component is positioned to block motion of the latch of the insulative housing to unlatch from the tab.

Optionally, the electrical connector further comprises a cover and a seal comprising an opening, the method further comprising: pushing the cover toward the insulative housing to urge the seal against the position assurance component.

Optionally, the electrical connector further comprises a cover and a seal comprising an opening, the method further comprising: urging the seal against the position assurance component by pushing the cover toward the insulative housing.

Optionally, pushing the cover toward the insulative housing comprises pushing a cover with a force having a magnitude; and the method further comprises detecting a mispositioning of the contact carrier when the magnitude of the force exceeds a threshold and the cover does not engage the insulative housing.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

1. An electrical connector, comprising:
an insulative housing comprising a chamber and a channel;
a position assurance component comprising an opening having a channel and a surface adjacent the channel; and
a contact carrier comprising a tab;
wherein, the position assurance component is slidably mounted in the insulative housing and configured to slide between an open position in which the channel of the insulative housing, the channel of the position assurance component, and the tab on the contact carrier align and a closed position in which the surface of the position assurance component aligns with the channel of the insulative housing.

2. The electrical connector as in claim 1, wherein:
the position assurance component has a wall bounding the channel;
the surface comprises one end of the wall; and
the position assurance component is in the closed position such that the surface interferes with withdrawal of the tab of the contact carrier through the channel.

3. The electrical connector as in claim 1 wherein:
the position assurance component comprises a latching feature comprising a slit; and
the insulative housing comprises a complementary latching feature, complementary to the latching feature of the position assurance component and configured to engage the latching feature when the position assurance component is at a predetermined position within the insulative housing.

4. The electrical connector as in claim 3, wherein:
the position assurance component comprises a body;
the latching feature comprises a member;
the slit separates the member from the body; and
the latching feature comprises a protrusion on the member.

5. The electrical connector as in claim 4, wherein:
the member is elongated in a direction between a first end and a second end; and
the member is attached to the body at the first end and the second end.

6. The electrical connector as in claim 4, wherein:
the member comprises a central portion between a first end and a second end; and
the protrusion extends from the central portion.

7. The electrical connector as in claim 3 wherein:
the complementary latching feature comprises a rut configured to engage with at least a portion of the latching feature of the position assurance component so as to hold the position assurance component in the predetermined position within the insulative housing.

8. The electrical connector as in claim 7 wherein:
the rut is a first rut;
the predetermined position is a first predetermined position;
the insulative housing comprises a second rut;
the second rut is configured to engage the latching feature when the position assurance component is in a second predetermined position within the insulative housing.

9. The electrical connector as in claim 1 comprising a plurality of contact carriers wherein:
the insulative housing comprises a plurality of chambers; and
the position assurance component comprises a plurality of openings.

10-16. (canceled)

17. A housing subassembly for an electrical connector, the subassembly comprising:
an insulative housing comprising a chamber having a channel;
a position assurance component comprising an opening having a channel and a surface adjacent the channel; and
wherein,
the position assurance component is slidably mounted in the insulative housing to slide between an open position in which the channel of the insulative housing and the channel of the position assurance component align and a closed position in which the surface of the position assurance component aligns with the channel on the insulative housing;
the position assurance component comprises a latch configured to engage a complementary structure in the insulative housing when the position assurance component is in the open position.

18. The housing subassembly as in claim 17, wherein:
the position assurance component comprises a body and a slit;
the latch comprises a member;
the slit separates the member from the body; and
the latch comprises a protrusion on the member.

19. The housing subassembly as in claim 18, wherein:
the member is elongated in a direction between a first end and a second end; and
the member is attached to the body at the first end and the second end.

20. The housing subassembly as in claim 19, wherein:
the member comprises a central portion between first end and the second end; and
the protrusion extends from the central portion.

21. The housing subassembly as in claim 20 wherein:
a complementary latching feature comprises a rut configured to engage with at least a portion of the latch of the position assurance component so as to hold the position assurance component in a predetermined position within the insulative housing.

22. The housing subassembly as in claim 21 wherein:
the rut is a first rut;
the predetermined position is a first predetermined position;
the insulative housing comprises a second rut;
the second rut is configured to engage the latch when the position assurance component is in a second predetermined position within the insulative housing.

23. The housing subassembly as in claim 17 further comprising four contact carriers wherein:
the insulative housing comprises four chambers; and
the position assurance component comprises four openings.

24. The housing subassembly as in claim 23 wherein the four openings of the position assurance component are arranged as a two-by-two matrix.

25. A method of operating an electrical connector comprising an insulative housing comprising a chamber and a channel, a position assurance component comprising an opening having a channel and a surface adjacent the channel, and a contact carrier comprising a tab, the method comprising:
with the position assurance component disposed at a first position at least partially within the insulative housing such that the channel of the insulative housing is aligned with the channel of the position assurance component, inserting the contact carrier through the opening of the position assurance component into the chamber of the insulative housing by aligning the tab of the contact carrier with the channel of the insulative housing and the channel of the position assurance component; and
sliding the position assurance component relative to the insulative housing such that the channel of the insulative housing is blocked by the position assurance component.

26. The method of operating an electrical connector as in claim 25, wherein the position assurance component further comprises a protrusion and the insulative housing comprises a first rut, the method further comprising:
pushing the position assurance component until the protrusion engages with the first rut of the insulative housing to secure the position assurance component in an open position within the insulative housing, whereby the position assurance component is held at the first position.

27. The method of operating an electrical connector as in claim 26 wherein the insulative housing comprises a second rut, wherein:
sliding the position assurance component relative to the insulative housing comprises pushing the position assurance component until the protrusion engages with the second rut to secure the position assurance component in a final position within the insulative housing.

28-39. (canceled)
